(19) United States
(12) Patent Application Publication
(10) Pub. No.: US 2006/0267875 A1
(43) Pub. Date: Nov. 30, 2006

(54) PLASMA DISPLAY PANEL HAVING LESS IMPEDANCE IN THE SINK DISCHARGE CURRENT PATH

(76) Inventors: Bi-Hsien Chen, Ping-Tung Hsien (TW); Yi-Min Huang, Taipei City (TW); Liang-Che Cho, Hsin-Chu Hsien (TW); Shin-Chang Lin, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/908,819

(22) Filed: May 27, 2005

(51) Int. Cl. G09G 3/28

(52) U.S. Cl. 345/68

(57) ABSTRACT

A driving circuit for plasma display panel includes a panel capacitor having a first end and a second end, a first switch having a first end connected to a first end of the panel capacitor and a second end coupled to a positive voltage source, a second switch having a first end connected to the first end of the panel capacitor and a second end coupled to a negative voltage source, a third switch having a first end connected to the second end of the first switch and a second end, and a fourth switch having a first end connected to the second end of the second switch and a second end connected to the second end of the third switch. The PDP driving circuit has less impedance in the sink discharge current path.

### BACKGROUND OF THE INVENTION

1. Field of the Invention

The present invention relates to a plasma display panel, and more particularly, to a plasma display panel having less impedance in the sink discharge current path.

2. Description of the Prior Art

Cathode ray tubes (CRTs) have been widely used as TV displays and excel in resolution and picture quality. However, the depth and weight of a CRT sharply increases as screen size increases. A CRT also has other disadvantages such as high power consumption, image flickering and possible health hazard after long-term use. Therefore, in order to obtain a planar, full-color, high-resolution TV with a large screen size, the plasma display panel (PDP) having a large screen size and a short depth has been developed. The PDP is advantageous in possible reduction in thickness thereof, and also in its large contrast in display without substantial image flickering as well as in possible enlargement of its screen. The PDP is further advantageous in high response speed and realizing a multicolor display by utilizing a fluorescent material illuminated by plasma discharges. In recent years, the PDP has been used widely in various fields of displays for computers and color displays. The PDP can be categorized into two types depending on the driving method. The first type is an alternating current (AC) PDP operated by an AC discharge indirectly between electrodes coated with dielectric films. The second type is a direct current (DC) PDP operated by a DC discharge directly between electrodes exposed to a discharge space. The AC PDP has been regarded as mainstream because of lower power consumption and longer lifetime.

A customary surface-discharge AC type PDP is composed of a display panel and a driving circuit. The PDP includes a plurality of discharge units, each having three electrodes. The driving circuit is for driving the three electrodes of each discharge unit, respectively, in accordance with the driving method and the driving procedures. The three electrodes in each discharge unit include an address electrode and two sustain electrodes: an X-electrode and a Y-electrode, respectively. In a PDP of a three-electrode lateral discharge structure, address electrodes are arranged intersecting the two parallel sustain X-electrode and Y-electrode, in a discharge space formed by barriers. In this structure, discharging for generating wall charges occurs between the address electrodes and the Y electrode in order to select a pixel, and then discharging for displaying an image is repeated for a predetermined period of time between the Y electrode and the X electrode. The barriers not only form the discharge space but also shield light generated when discharge occurs to prevent crosstalk between neighboring pixels. A plurality of unit structures obtained as above is formed on a substrate in a matrix form, and a fluorescent material is coated on each unit structure to construct one pixel. A plurality of pixels formed in this manner form a PDP. A commercially available surface-discharge AC type PDP is constructed in such a manner that discharging occurs in each pixel, and ultraviolet rays generated according to the discharge excite fluorescent material coated on the inner wall of each pixel to produce a desired color.

The circuit characteristic of the PDP is somewhat equivalent to a capacitor-like load. The driving method is to impose a high-voltage and high-frequency alternating voltage on both ends of the capacitor-like load so that the charges in the plasma display unit are driven back and forth. The driving sequence of a conventional surface-discharge AC type PDP has the following periods: (1) reset period, (2) scan period, and (3) sustaining period. In the reset period, the PDP imposes a large potential difference on the X and Y sustaining electrodes of which the primary purpose is to generate the same amount of wall charges in each of the display units so that image data can be correctly recorded in the subsequent scan period. The dischargeable gas in the plasma display unit can be excited and ionized in the sustaining period so as to discharge and result in image display.

During a sustain period of a PDP driving circuit, a sustain pulse of Vsus is alternately applied to the sustain electrodes X and the sustain electrodes Y, resulting in a large voltage difference between electrodes and high discharge currents in the PDP driving circuit. When a sustain pulse of a positive voltage Vsus is applied to the sustain electrodes X and the sustain electrodes Y is set to ground, the resulting discharge current is called a sink discharge current.

FIG. 1 is diagram of a prior art PDP 10. The PDP 10 comprises a panel capacitor Cp having an X side and a Y side, a plurality of switches S1-S10, and a plurality of voltage sources. The switches S1 through S10 in the PDP 10 are each an N-type metal oxide semiconductor field effect transistor (MOSFETs) with a body diode. The PDP 10 is coupled to different voltage sources Vsus, Vset, VscH, Ve and −VscL for supplying operating voltages during the reset period, the scan period, and the sustaining period of the PDP. The voltage of Vset is larger than the voltage of Vsus and the voltage of Ve is lower than the voltage of Vsus. Each switch in the path of discharge currents requires a heat sink for heat dissipation and a high-voltage integrated circuit (HVIC) for controlling the switches. In the PDP 10, two possible sink discharge current paths are:

Path 1: S8(channel)→Cp→S1 (diode)→S3(channel)→S4→S5(channel)→S7(channel); and

Path 2: S8(channel)→Cp→S2(channel)→S4→S5(channel)→S7(channel).

Since the sink discharge current pass through many MOSFETs, the impedances of the sink diode discharge current paths are also considerable. Since higher path impedances downgrade the performance of the PDP, it is desirable to lower the impedances of the sink diode discharge current paths in the PDP driving circuit.

### SUMMARY OF THE INVENTION

It is therefore an objective of the claimed invention to provide a plasma display panel having less impedance in the sink discharge current path.

The claimed invention discloses a plasma display panel comprising a panel capacitor having a first end and a second end, a first switch having a first end coupled to the first end of the panel capacitor and a second end coupled to a voltage source, a second switch having a first end connected to the first end of the panel capacitor and a second end coupled to a negative voltage source, a third switch having a first end coupled to the second end of the first switch and a second end, and a fourth switch having a first end coupled to the second end of the second switch and a second end coupled to the second end of the third switch.

The claimed invention also discloses a plasma display panel comprising a panel capacitor having a first end and a second end, a first switch having a first end coupled to a first end of the panel capacitor and a second end coupled to a positive voltage source, a second switch having a first end coupled to the first end of the panel capacitor and a second end, and a third switch having a first end coupled to the second end of the first switch and a second end coupled to the second end of the second switch.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a prior art plasma display panel.

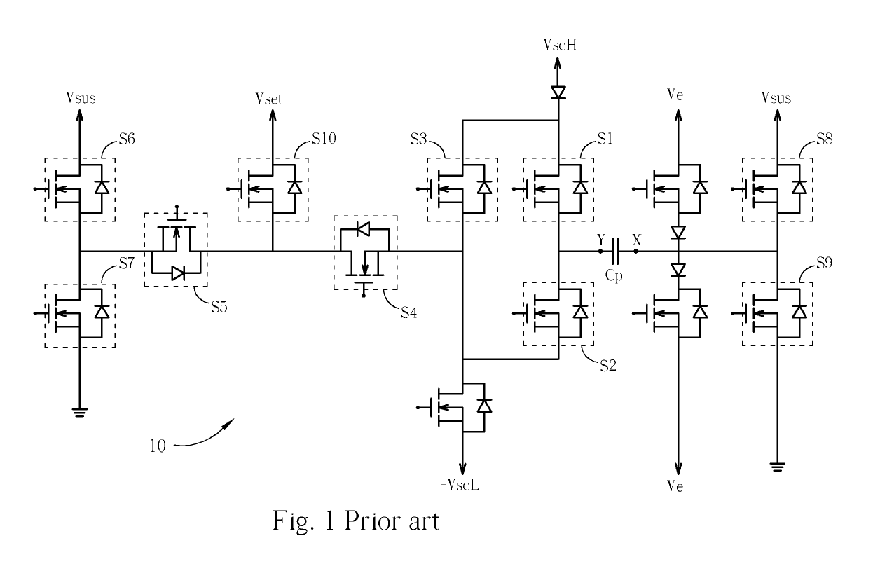

FIG. 2 shows a timing diagram of a driving method for a three-electrode surface-discharge type plasma display panel.

FIG. 3 shows a plasma display panel according to the first embodiment of the present invention.

FIG. 4 shows a plasma display panel according to the second embodiment of the present invention.

FIG. 5 shows a plasma display panel according to the third embodiment of the present invention.

FIG. 6 shows a plasma display panel according to the fourth embodiment of the present invention.

FIG. 7 shows a plasma display panel according to the fifth embodiment of the present invention.

FIG. 8 shows a plasma display panel according to the sixth embodiment of the present invention.

FIG. 9 shows a plasma display panel according to the seventh embodiment of the present invention.

### DETAILED DESCRIPTION

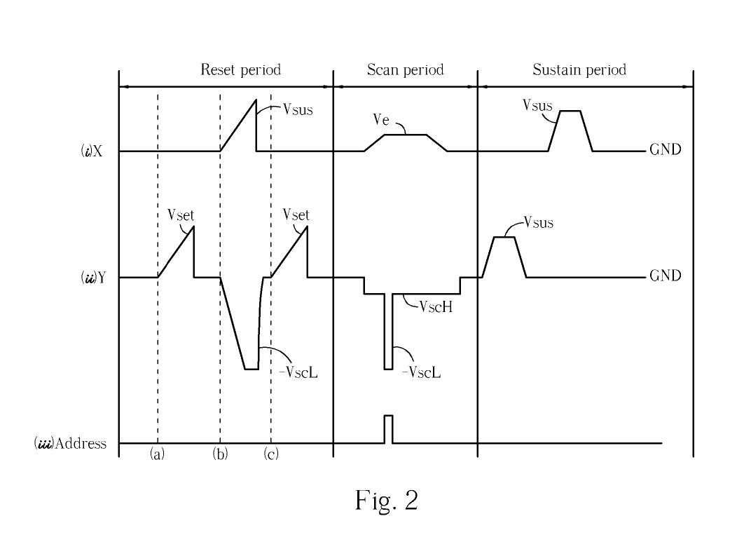

FIG. 2 is a timing diagram of a driving method for a three-electrode surface-discharge type PDP device. The driving method can be divided into several sub-fields. In FIG. 2, (i), (ii) and (iii) are voltage waveforms applied to the sustain electrodes X, the sustain electrodes Y, and the address electrodes, respectively, during the reset period, scan period, and sustain period of one frame in accordance with the driving method. During process (a), all electrodes are set to 0 V, and a pulse of a positive voltage Vset is applied to the sustain electrodes Y. Next, during process (b), all electrodes are set to 0 V, a pulse of a positive voltage Vsus is applied to the sustain electrodes X, and a pulse of a negative voltage −VscL is applied to the sustain electrodes Y. In normal discharge cells, processes (a) and (b) completely neutralize wall charges or reduce them to an extent that no display errors occur due to the remnant wall charges. The polarities of the remnant wall charges are integrated by the discharge of processes (a) and (b). In addition, the discharge in processes (a) and (b) uniformly distributes wall charges. The voltage of the next erase pulse is added to the wall charges, to adjust the quantity of the wall charges into one that is sufficient to discharge the wall charges. During process (c), all electrodes are set to 0 V, and an erase pulse of a positive voltage Vset is applied to the sustain electrodes Y. This pulse gently rises. This results in mostly erasing the wall charges even if a discharge start voltage varies from cell to cell. Then, the scan period starts. An address pulse is applied to the address electrodes. The scan pulse of voltages VscH and −VscL is applied to the sustain electrodes Y. The sustain electrodes X are set to Ve. During the sustain period, a sustain pulse of a positive voltage Vsus is alternately applied to the sustain electrodes X and Y. The number of the sustain pulses is determined in accordance with the sub-fields actually needed.

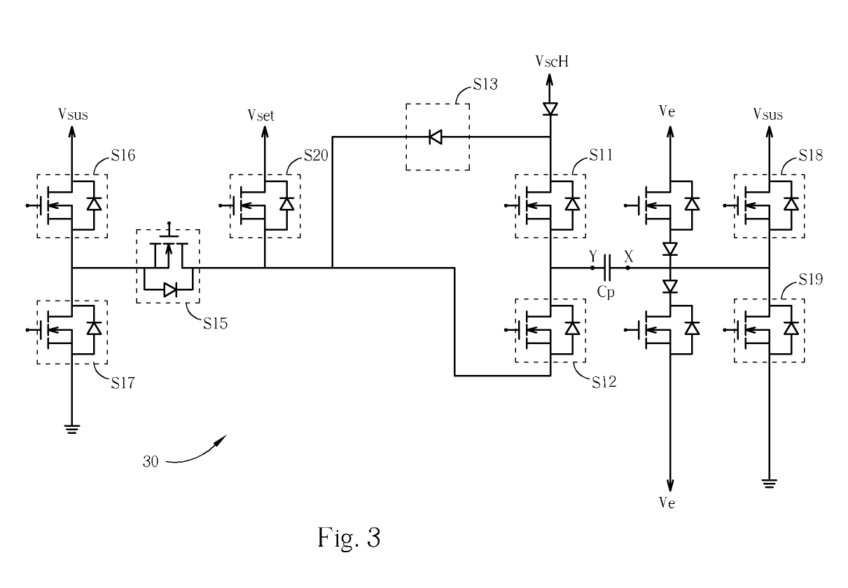

Please refer to FIG. 3 for a plasma display panel PDP 30 according to the first embodiment of the present invention. The PDP 30 comprises a panel capacitor Cp having an X side and a Y side, a plurality of switches S11-S13 and S15-S20, and a plurality of voltage sources Vsus, Vset, VscH and Ve for supplying operating voltages for the PDP 30. In PDP 30 each of the switches S11-S12 and S15-S20 is an N-type metal oxide semiconductor field effect transistor (MOSFET) with a body diode, but other devices with similar function, such as insulated gate bipolar transistors (IGBTs) with a body diode, can also be adopted. The switch S13 is a diode, but other devices with similar function, such as MOSFETs with a body diode, can also be adopted. In the PDP 30, one end of the switch S13 (the cathode of the diode) is coupled to the source of the switch S12 without an intermediate switch. Also, the PDP 30 does not require the negative voltage source −VscL. In the PDP 30, two possible sink discharge current paths are:

Path 3: S18(channel)→Cp→S11(diode)→S13(diode)→S15(channel)→S17(channel)

Path 4: S18(channel)→Cp→S12(channel)→S15(channel)→S17(channel)

Since in the PDP 30, the sink discharge current paths Path 3 and 4 include fewer devices than the sink discharge current paths Path 1 and 2 of the prior art PDP 10, the impedance of the sink discharge current paths can be lowered. Therefore, the PDP 30 has better performance. Also, the PDP 30 utilizes a diode for the switch S13 instead of a MOSFET with a body diode, so it can lower the cost for a heat sink for heat dissipation and a high-voltage integrated circuit (HVIC) for controlling the switch. In the prior art PDP 10, reducing device cost cannot be achieved with the same method. If the switch S3 in the prior art PDP 10 is a diode instead of a MOSFET with a body diode, the switch S3 will be conducting during the scan period when a negative voltage VscL is applied, and the PDP will not be able to function normally during this period. But in the PDP 30 of the present invention, the negative voltage source −VscL is not required. Therefore, the PDP 30 does not require an intermediate switch S4 for preventing the switch S13 from conducting when a negative voltage VscL is applied during the scan period.

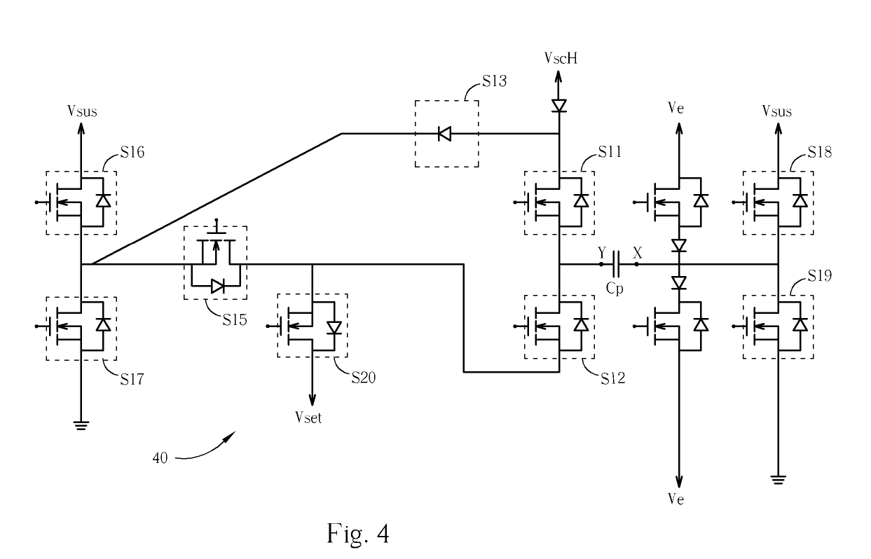

Please refer to FIG. 4 for a plasma display panel PDP 40 according to the second embodiment of the present invention. The PDP 40 differs from the PDP 30 in that one end of the switch S13 (the cathode of the diode) is connected to the source of the switch S15 instead of the source of the switch 12. Otherwise, like reference numerals identify like elements. In the PDP 40, two possible sink discharge current paths are:

Path 5: S18→Cp→S11→S13→S17

Path 6: S18→Cp→S12→S15→S17

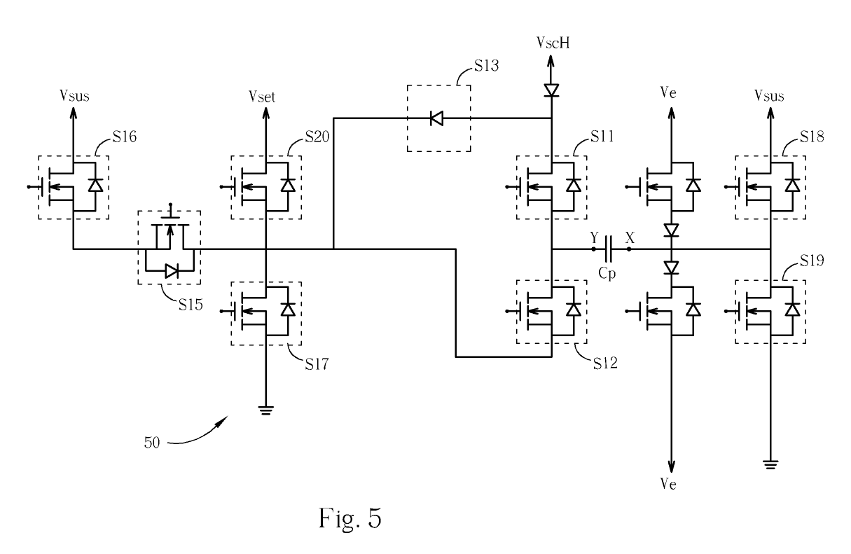

Please refer to FIG. 5 for a plasma display panel PDP 50 according to the third embodiment of the present invention. The PDP 50 differs from the PDP 30 in that the drain of the switch S17 is connected to the drain of the switch S15 instead of the source of the switch S15. Otherwise, like reference numerals identify like elements. In the PDP 50, two possible sink discharge current paths are:

Path 7: S18→Cp→S11→S13→S17

Path 8: S18→Cp→S12→S17

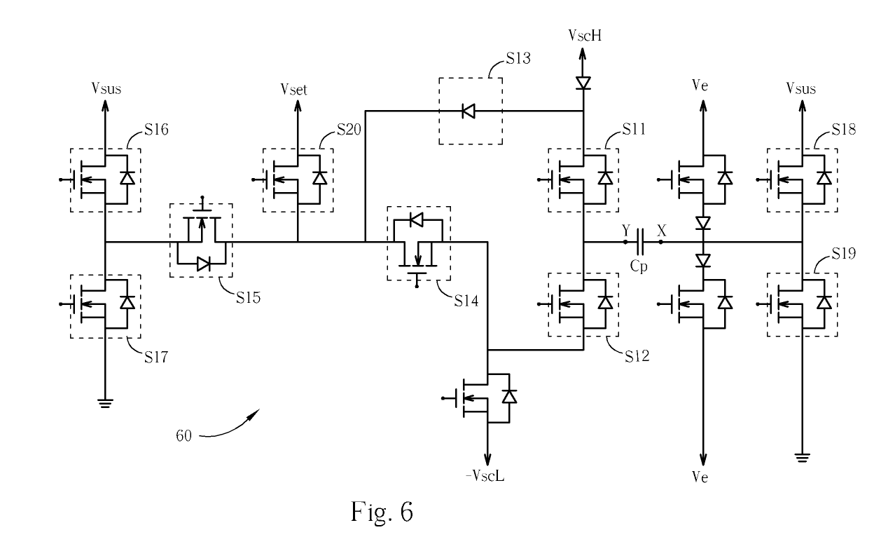

Please refer to FIG. 6 for a plasma display panel PDP 60 according to the fourth embodiment of the present invention. The PDP 60 comprises a panel capacitor Cp having an X side and a Y side, a plurality of switches S11-S20, and a plurality of voltage sources Vsus, Vset, VscH, Ve and −VscL for supplying operating voltages for the PDP 60. In PDP 60 each of the switches S11-S12, S14-S20 is an N-type MOSFET with a body diode, but other devices with similar function, such as IGBTs with a body diode, can also be adopted. The switch S13 is a diode, but other devices with similar function, such as MOSFETs with a body diode, can also be adopted. Unlike in the prior art PDP10 where one end of the switch S3 (the drain of the MOSFET) is connected to the switch S1 and another end (the source of the MOSFET) is connected to the source of the switch S4, in the PDP 60 one end of the switch S13 (the anode of the diode) is connected to switch S11 and another end (the cathode of the diode) is connected to the drain of switch S14. In the PDP 60, two possible sink discharge current paths are:

Path 9: S18→Cp→S11→S13→S15→S17

Path 10: S18→Cp→S12→S14→S15→S17

Since the sink discharge current paths Path 9 and 10 of the PDP 60 include fewer devices than the sink discharge current paths Path 1 and 2 of the prior art PDP 10, the impedance of the sink discharge current paths can be lowered. Therefore, the PDP 60 has better performance. Also, the PDP 60 utilizes a diode for the switch S13 instead of a MOSFET with a body diode, so it can lower the cost for a heat sink for heat dissipation and a HVIC for controlling the switch. As mentioned before, reducing device cost cannot be achieved with the same method in the prior art PDP 10. However in the PDP 60 of the present invention, the diode used for the switch S13 is coupled to the VscL through the switch S14 which is a MOSFET with a body diode. The switch S14 prevents the switch S13 from conducting when a negative voltage VscL is applied to the PDP 30 during the scan period.

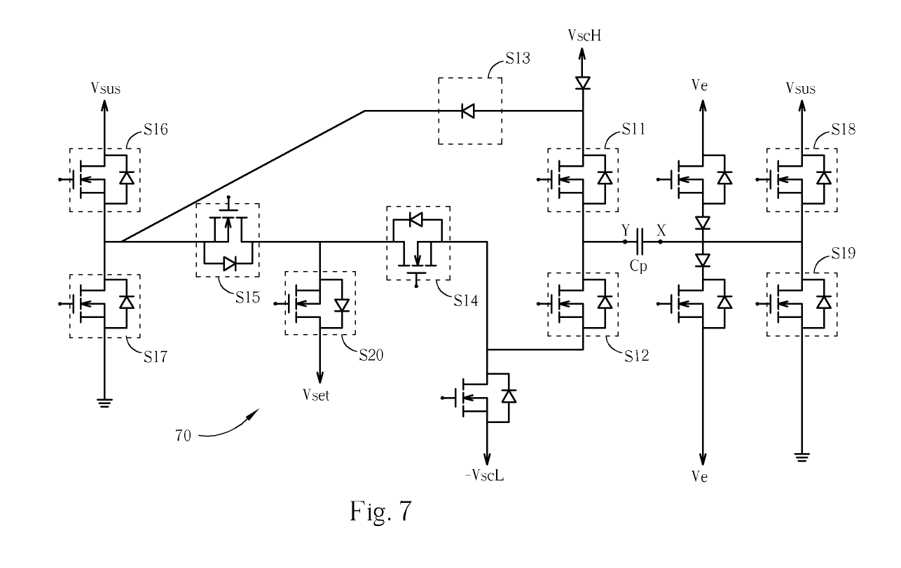

Please refer to FIG. 7 for a plasma display panel PDP 70 according to the fifth embodiment of the present invention. The PDP 70 differs from the PDP 60 in that one end of the switch S13 (the cathode of the diode) is connected to the source of the switch S15 instead of he drain of switch S14. Otherwise, like reference numerals identify like elements. In the PDP 70, two possible sink discharge current paths are:

Path 11: S18→Cp→S11→S13→S17

Path 12: S18→Cp→S12→S14→S15→S17

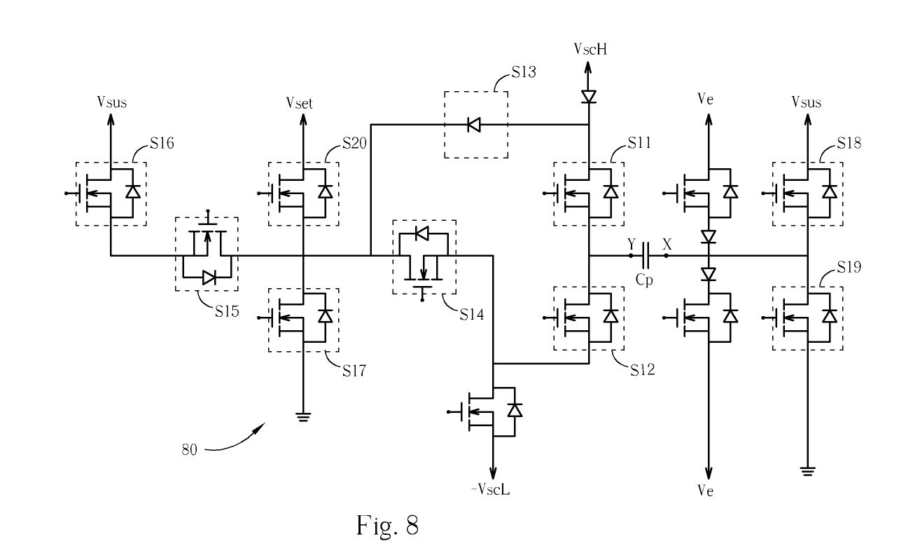

Please refer to FIG. 8 for a plasma display panel PDP 80 according to the sixth embodiment of the present invention. The PDP 80 differs from the PDP 60 in that the drain of the switch S17 is connected to the drain of the switch S15 instead of the source of the switch S15. Otherwise, like reference numerals identify like elements. In the PDP 50, two possible sink discharge current paths are:

Path 13: S18→Cp→S11→S13→S17

Path 14: S18→Cp→S12→S14→S17

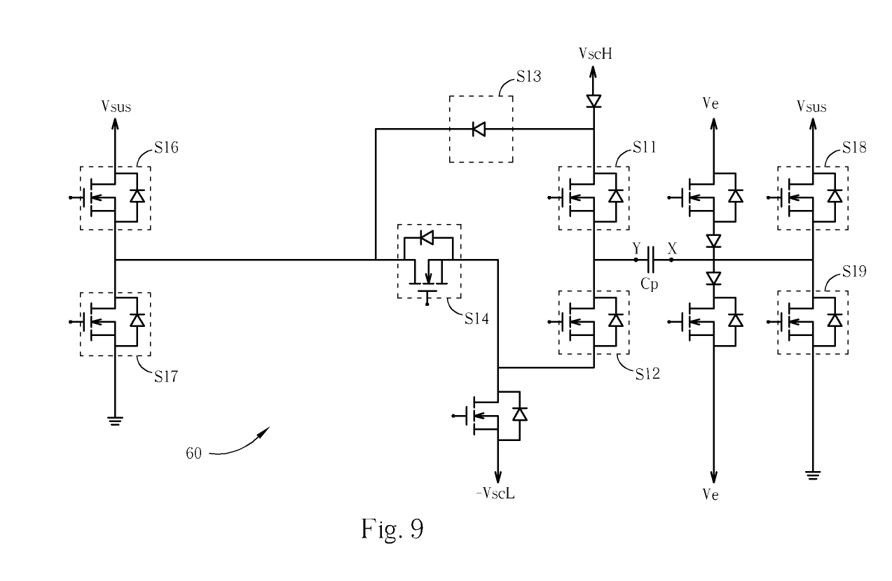

Please refer to FIG. 9 for a plasma display panel PDP 90 according to the seventh embodiment of the present invention. The PDP 90 differs from the PDP 60 in that the PDP 90 does not include the switch S15, S20 and Vset. Otherwise, like reference numerals identify like elements. In the PDP 60, two possible sink discharge current paths are:

Path 15: S18→Cp→S11→S13→S17

Path 16: S18→Cp→S12→S14→S17

Compared to the sink discharge current paths Path 1 and 2 in the prior art PDP, the sink discharge current paths Path 3-16 include fewer devices and therefore have less impedance. Also, the present invention utilizes a diode for the switch S13 instead of a MOSFET with a body diode. Thus the cost for a heat sink for heat dissipation and HVIC for controlling the switch can be reduced. In conclusion, the present invention not only reduces manufacturing cost of a PDP, it also provides better control and easier design for the devices of the PDP.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A plasma display panel comprising:
a panel capacitor having a first end and a second end;
a first switch having a first end coupled to a first end of the panel capacitor and a second end coupled to a voltage source;
a second switch having a first end coupled to the first end of the panel capacitor and a second end coupled to a negative voltage source;
a third switch having a first end coupled to the second end of the first switch and a second end; and
a fourth switch having a first end coupled to the second end of the second switch and a second end coupled to the second end of the third switch.

2. The plasma display panel of claim 1 further comprising a diode having a first end coupled to the voltage source and a second end coupled to the second end of the second switch.

3. The plasma display panel of claim 1 further comprising a fifth switch having a first end coupled to the second end of the second switch and a second end coupled to a negative voltage source.

4. The plasma display panel of claim 3 further comprising:
a sixth switch having a first end coupled to a positive voltage source and a second end coupled to the second end of the third switch; and
a seventh switch having a first end coupled to ground and a second end coupled to the second end of the sixth switch.

5. The plasma display panel of claim 4 further comprising:
an eighth switch coupled between the second end of the sixth switch and the second end of the fourth switch;
a ninth switch having a first end coupled to a positive voltage source and a second end coupled between the second end of the fourth switch and the second end of the eighth switch.

6. The plasma display panel of claim 4 further comprising:
an eighth switch having a first end coupled to a positive voltage source and a second end coupled to the second end of the sixth switch.

7. The plasma display panel of claim 1 wherein each of the first, second, third and fourth switch is a metal oxide semiconductor field effect transistor (MOSFET) with a body diode or an insulated gate bipolar transistor (IGBT) with a body diode.

8. The plasma display panel of claim 1 wherein the third switch is a diode.

9. The plasma display panel of claim 3, 4 and 5 wherein each of the switches is a MOSFET with a body diode or an IGBT with a body diode.

10. A plasma display panel comprising:
a panel capacitor having a first end and a second end;
a first switch having a first end coupled to a first end of the panel capacitor and a second end coupled to a positive voltage source;
a second switch having a first end coupled to the first end of the panel capacitor and a second end; and
a third switch having a first end coupled to the second end of the first switch and a second end coupled to the second end of the second switch.

11. The plasma display panel of claim 10 further comprising a diode having a first end coupled to a positive voltage source and a second end coupled to the second end of the second switch.

12. The plasma display panel of claim 11 further comprising:
a fourth switch having a first end coupled to a positive voltage source and a second end coupled to the second end of the third switch;
a fifth switch having a first end coupled to ground and a second end coupled to the second end of the fourth switch; and
a sixth switch having a first end coupled to a positive voltage source and a second end coupled to the second end of the fourth switch.

13. The plasma display panel of claim 11 further comprising:
a fourth switch having a first end coupled to a positive voltage source and a second end coupled to the second end of the third switch;
a fifth switch having a first end coupled to the second end of the fourth switch and a second end;
a sixth switch having a first end coupled to a positive voltage source and a second end coupled to the second end of the fifth switch; and
a seventh switch having a first end coupled to ground and a second end coupled to the second end of the fifth switch.

14. The plasma display panel of claim 11 further comprising:
a fourth switch having a first end coupled to the second end of the third switch and a second end coupled to the second end of the second switch;
a fifth switch having a first end coupled to a positive voltage source and a second end coupled between the second ends of the second switch and fourth switch;
a sixth switch having a first end coupled to a positive voltage source and a second end coupled to the first end of the fourth switch; and
a seventh switch having a first end coupled to ground and a second end coupled to the first end of the fourth switch.

15. The plasma display panel of claim 10 wherein each of the first, second and third switch is a MOSFET with a body diode or an IGBT with a body diode.

16. The plasma display panel of claim 10 wherein the third switch is a diode.

17. The plasma display panel of claim 13 and 14 wherein each of the switches is a MOSFET with a body diode or an IGBT with a body diode.
